(19) United States
(12) Patent Application Publication
(10) Pub. No.: US 2002/0064409 A1
(43) Pub. Date: May 30, 2002

(54) Printer ribbon cartridge with reinking roller

(75) Inventor: Felix Alan Scaife Gibson, Bratlslava (SK)

Correspondence Address: Dike, Bronstein, Roberts & Cushman, Intellectual Property Patent Practice, EDWARDS & ANGELL, LLP, P.O. Box 9169, Boston, MA, 02209, US

(73) Assignee: GTECH Rhode Island Corporation

(21) Appl. No.: 09/981,373

(22) Filed: Oct. 17, 2001

Related U.S. Application Data
(60) Provisional application No. 60/241,075, filed on Oct. 17, 2000.

(51) Int. Cl. B41J 32/00

(52) U.S. Cl. 400/196; 400/191

(57) ABSTRACT

A printer ribbon cartridge having a base and a removable hinged lid is disclosed, wherein ribbon is driven through the cartridge by a drive gear coupled with first and second idler gears. A foam reinking roller supplies ink to an ink transfer roller which transfers ink to the ribbon as it passes thereby. The reinking roller includes sandwiched foam layers with an ink impervious layer therebetween, in order to control ink seepage and ensure an adequate reinking across the width of the ribbon. A ribbon chamber surrounds the reinking roller in a semicircular formation to store the ribbon in folds corresponding to the width of the ribbon chamber, thus maximizing ribbon storage space in the cartridge.

### FIELD OF INVENTION

The present invention resides in the field of ribbon cartridges for printers, and more particularly relates to a printer ribbon cartridge with reinking rollers for transferring ink to a ribbon.

### BACKGROUND OF THE INVENTION

Printer ribbon cartridges (i.e. ink ribbon cartridges) are commonly used with various types of impact printers. An example of such an impact printer is one designed to operate in a lottery terminal, which is used to print lottery tickets that are sold to the public. The printer ribbon cartridge is used in conjunction with a dot matrix printer to print on, e.g., either a continuous roll of paper or pre-cut paperboard tickets. The paper can be fed through a gap in the front of the printer cartridge between the cartridge and the printer ribbon. A reciprocating print head engages the ribbon in this region and causes the ribbon to contact the paper, thus forming predetermined characters on the paper.

The ribbon in a printer ribbon cartridge is advanced in a given direction by a drive source external to the cartridge. To drive the ribbon, a drive spindle in the printer can engage a drive gear in the cartridge. The drive gear and an opposing idler gear drive the ribbon through the cartridge and outside the cartridge at the front region thereof in the vicinity of the print head.

Some printer ribbon cartridges provide for reinking of the ribbon, which increases the useful life of the printer cartridge over “single strike” ribbon cartridges. Reinking can be accomplished by passing the ribbon over a foam reinker, which is saturated with ink, in order to transfer ink to the ribbon. Often the foam reinker is in the form of a cylinder which rotates and transfers ink to the ribbon as the ribbon passes the reinker. A problem in prior art reinkers is oversaturation or undersaturation of the ribbon. A reinking transfer roller can be used to regulate the amount of ink transferred to the ribbon. The transfer roller can be positioned in the path of the ribbon such that one side contacts the foam reinker and the other side is in contact with the ribbon. The transfer roller rotates while engaging the ribbon, causing the foam reinker to rotate, and thus transferring ink from the foam reinker to the transfer roller and then to the ribbon. In this manner ink is continuously applied to the ribbon.

Another problem in prior art reinking systems is the inability to distribute an even supply of ink across the width of the ribbon. Existing foam reinking rollers generally comprise a single piece of foam machined to a desired diameter. U.S. Pat. No. 5,713,677 describes a typical foam reinker in which the consistency of the foam material is continuous over the width of the foam. Due to gravity, the ink held in the foam tends to settle over time, resulting in a higher concentration of ink near the bottom of the roller and a lower concentration near the top thereof. Thus, ink is applied in an uneven manner across the width of the ribbon, causing the ribbon to print in varying levels of darkness. The result is a lower quality of printing, which reduces the useful life of the printer cartridge.

A further problem which tends to limit printer cartridge life relates to the size of the ribbon-holding chamber in the printer cartridge. Typical printer cartridges are limited by the size constraints and dimensions of the particular machine in which they are installed. It is desirable to maximize the size of the chamber in order to accommodate a greater length of ribbon in the cartridge, thereby reducing wear on the length of ribbon. Prior art printer cartridges with generally rectangular-shaped chambers often fail to make efficient use of the available space.

Thus, it would be advantageous to provide an improved printer ribbon cartridge with a longer useful life having a larger chamber surface area for accommodating a longer length of ribbon, and one that provides an even reinking across the width of the ribbon.

### SUMMARY OF THE INVENTION

A printer ribbon cartridge is disclosed having a base covered by a removable hinged lid, wherein a length of ribbon is conveyed along a path through the cartridge, extending outside the cartridge at the front thereof to print characters on paper. A drive gear provides the drive source for the ribbon. First and second idler gears are meshed with the drive gear to drive the ribbon through the cartridge without slip while overcoming friction generated by the ribbon undergoing various turns and contacting posts situated along the path. In particular, the ribbon passes an angled entry arm to enter the cartridge, whereupon it is directed toward a foam reinking roller situated near the center of the cartridge. An ink transfer roller is positioned between the ribbon and the foam reinking roller in order to transfer a regulated amount of ink to the ribbon.

The particular construction and location of the foam reinking roller contributes to the useful life of the printer cartridge. The foam reinking roller preferably is situated in approximately the middle of the printer cartridge and is constituted by multiple sandwiched foam pieces forming a cylindrical roller. In a preferred embodiment, two foam pieces are stacked together, and an ink impervious layer is situated therebetween. The reinking roller can be of a height greater than the width of the ribbon to ensure adequate inking across the ribbon width.

Separating the upper and lower foam pieces is the aforementioned ink impervious layer, which prevents the passage of ink, wherein the ink impervious layer is preferably positioned at a level corresponding to the middle of the ribbon. As the width of the ribbon is preferably about 2/3 of the height of the reinking roller, the height of the upper foam piece can be approximately twice that of the lower foam piece. The level of the ink impervious layer relative the ribbon is significant in that it prevents ink from the upper foam piece from settling to the lower half of the reinking roller, thereby ensuring an adequate supply of ink for inking the top half of the ribbon. This results in a longer useful life for the ribbon.

The ribbon chamber preferably is oriented and positioned in order to maximize the ribbon-holding capacity of the printer cartridge. The ribbon chamber comprises a significant percentage of the volume of the printer cartridge, wherein the chamber stores ribbon in folds, each fold having a size approximately equal to the width of the chamber. The chamber maintains a constant width and is oriented in a semicircular shape around the outside of the foam reinking roller. Because the chamber is preferably of circular or semicircular shape, the folds tend to follow each other along the chamber path and overlap but not interfere with each other. This shape maximizes the available space for ribbon in the cartridge by contouring the chamber to complement the shape of the reinking roller.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 is a perspective view of an inside of the printer ribbon cartridge of the present invention;

FIG. 2 is a top view looking inside the printer cartridge, wherein the cartridge is rotated from the view of FIG. 1;

FIG. 3 is a top view of the printer cartridge of FIG. 2 with the lid attached;

FIG. 4 is an exploded perspective view of parts of the foam reinking roller; and

FIG. 5 is a perspective side view of the ink transfer roller.

### DETAILED DESCRIPTION OF THE PREFERRED EMBODIMENT(S)

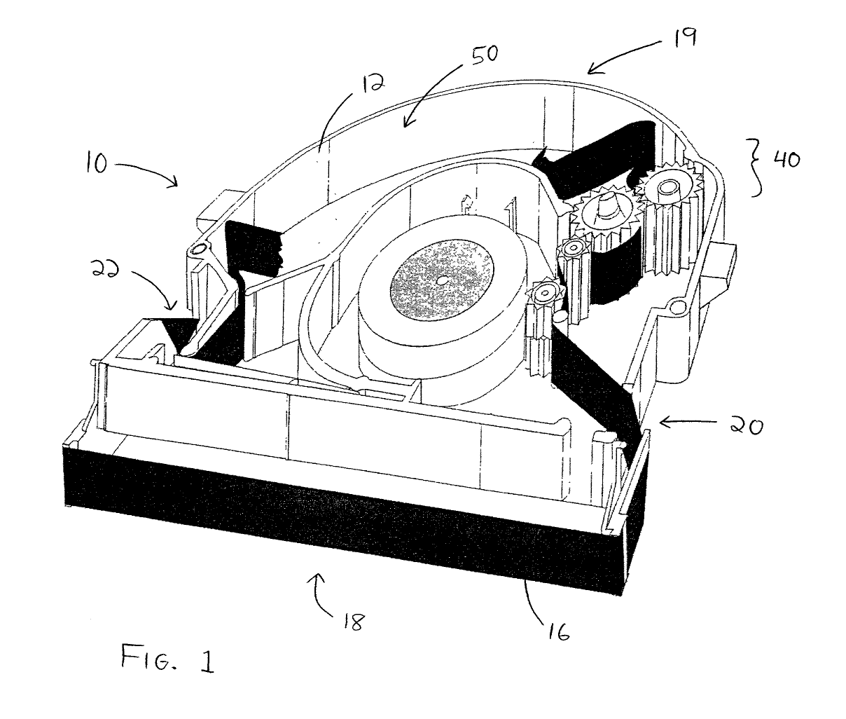

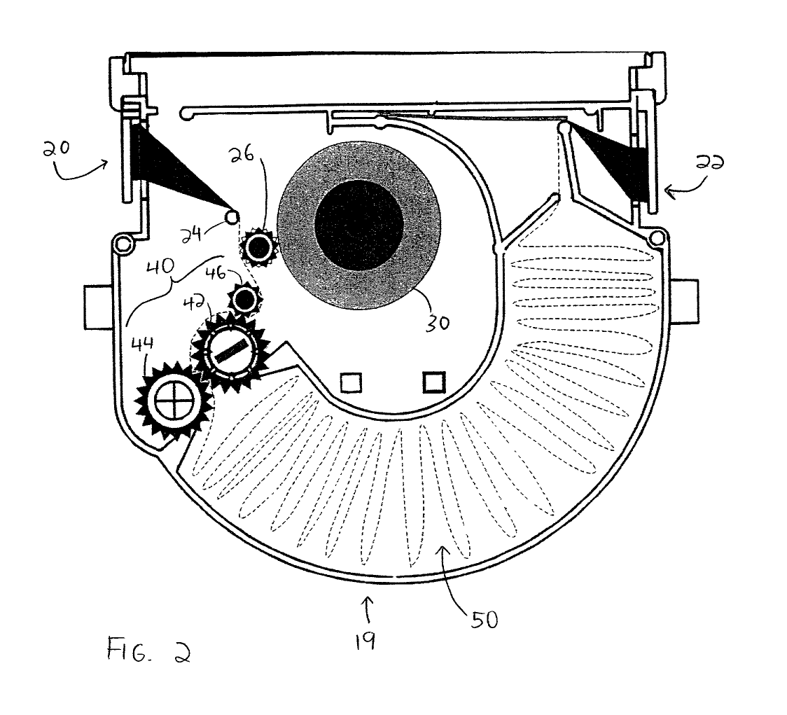

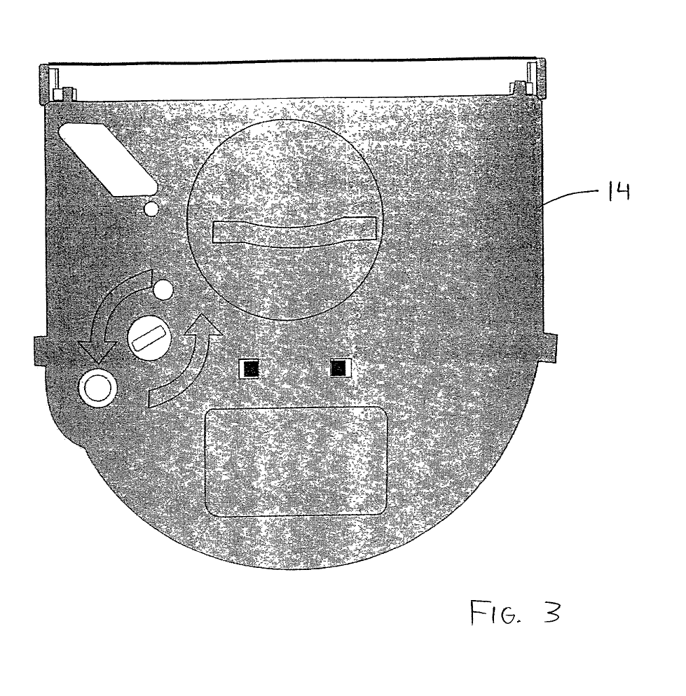

FIGS. 1 and 2 illustrate a printer ribbon cartridge 10 of the present invention, wherein the cartridge includes a base 12 and a lid 14 (see FIG. 3) attached to the base. The lid is hinged to base 12 by hinges (not shown) located on either side of the cartridge in a front region 18, such that the lid can be removed easily for replacement of parts or routine maintenance as needed. A continuous length of ribbon 16 runs through the cartridge and extends outside the cartridge at front region 18. In the front region, a print head (not shown) engages the ribbon to print characters on paper (not shown). Ribbon 16 enters the cartridge through an entry area 20, and then follows a path through the cartridge, exiting at exit area 22.

Ribbon 16 is driven through the ribbon cartridge by a drive assembly 40, including a drive wheel 42 which is driven by a source external to the cartridge (e.g. a motor). Drive wheel 42 engages with a first idler wheel 44, which can preferably be of approximately the same size as the drive wheel. The engagement of wheels 42 and 44 drives the ribbon that is interposed between them. Drive wheel 42 and first idler wheel 44 are preferably cog wheels having alternating outer teeth which mesh with each other to drive the ribbon through the cartridge. The size and shape of the wheels helps determine the size of folds generated by the drive wheel and first idler wheel. The wheels are sized in a manner well known to those skilled in the art to produce folds of a width substantially equal to the width of chamber 50, discussed in greater detail below. The printer cartridge includes a second idler wheel 46 (i.e. a third cog wheel) which is positioned upstream of the drive wheel and first idler wheel to enable the ribbon to overcome friction forces generated along the ribbon path. Second idler wheel 46 meshes with drive wheel 42 upstream of the engagement between the drive wheel and first idler wheel. The second idler wheel is preferably smaller than the drive wheel 42 in order to reduce the surface area of the printer cartridge that is consumed by the drive assembly.

After the ribbon is conveyed through entry area 20 into the cartridge, it is conveyed along a path following various angles and curves around a post 24 and through the drive assembly. In the drive assembly, the ribbon first curves around second idler wheel 46 and then curves around drive wheel 42 to the nip between the drive wheel and first idler wheel 44. Positioned upstream of the drive assembly between the second idler wheel and post 24 is an ink transfer roller 26 rotatably disposed on base 12, wherein the foam reinking roller 30 is caused to rotate through engagement with the transfer roller 26. The ribbon contacts the transfer roller and thus produces rotation of the transfer roller which rotates the foam reinking roller, transferring ink from the foam reinking roller 30 to the transfer roller 26 and to the ribbon.

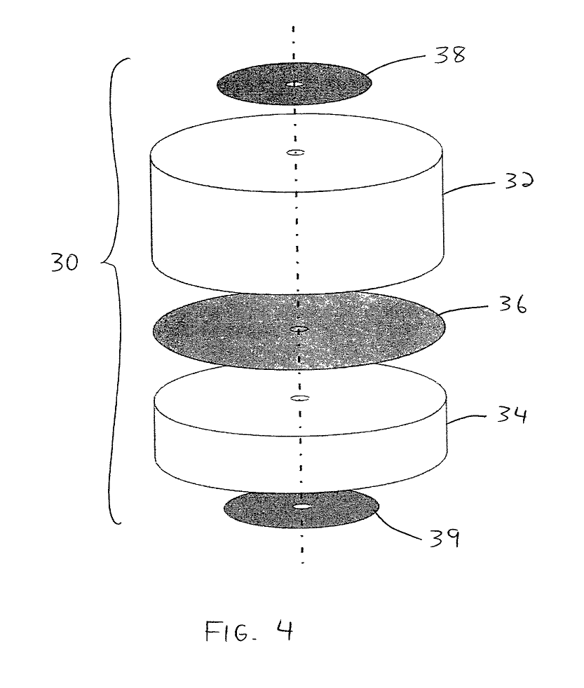

As seen in FIG. 4, the foam reinking roller 30 preferably includes a sandwiched upper foam piece 32 and a lower foam piece 34, with an ink impervious layer 36 situated therebetween. The foam reinking roller can be of a height which is greater than the width of the ribbon, preferably about 2/3 greater, such that the upper foam piece is generally about twice the height of the lower foam piece. The ink impervious layer is situated between foam pieces 32 & 34 at a height corresponding to approximately the middle of the ribbon width. Ink tends to settle within foam, which over time can lead to an uneven reinking of the ribbon, or, if the print head writes a top and a bottom line of print on the ribbon at the same time, a “zebra-like” striping effect. Such effects are controlled by the present arrangement which provides for an ink impervious layer between multiple foam pieces, in order to prevent ink settling from the upper foam piece to the lower foam piece. The resulting anti-zebra foam reinking roller has a longer useful life because readable print life is increased by giving more even reinking across the width of the ribbon due to the ink in the top part of the foam not being able to settle to the bottom part.

As shown in FIG. 4, flanges 38 & 39 are mounted on either side of sandwiched foam reinking roller 30, with upper flange 38 attached to the top of upper foam piece 32 and lower flange 39 attached to the bottom of lower foam piece 34. The flanges act to prevent rubbing between the reinking roller and the lid and base, respectively, in order to ensure a smooth rotation of the reinking roller. The flanges can be made of any suitable material, for example a plastic.

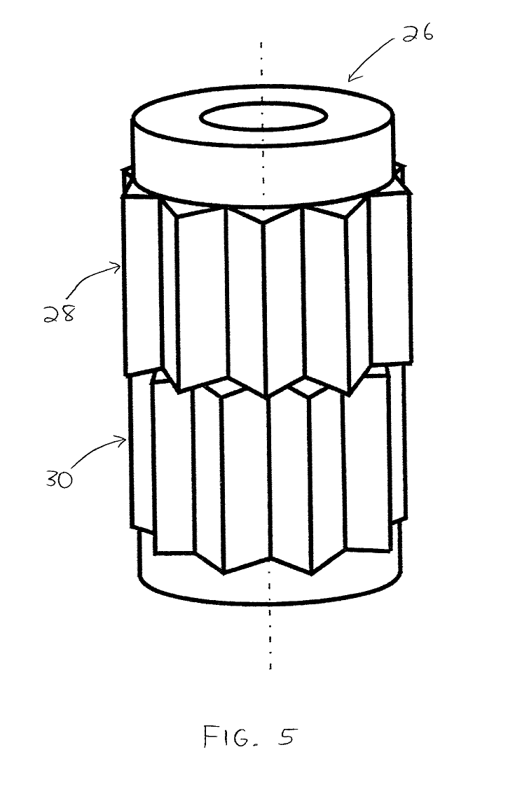

FIG. 5 shows an enlarged view of a preferred embodiment of ink transfer roller 26. The ink transfer roller transfers ink from the reinking roller to the ribbon across the width of the ribbon. The transfer roller has a staggered arrangement of deeply serrated teeth with a first level 28 and a second level 30 arranged in a sandwiched formation. The teeth are serrated in a manner and depth which ensure that ink rests only on the tips thereof, adjusting the speed of reinking to avoid oversaturation or undersaturation of the ribbon whilst providing for an even distribution of ink over the ribbon width.

Downstream of drive assembly 40 is ribbon chamber 50 which stores the ribbon in neat folds (as shown, e.g., in FIG. 2) produced by drive wheel 42 and first idler wheel 44. The ribbon chamber is situated at a rear region 19 of the printer cartridge, and preferably has a semicircular shape curving around the reinking roller 30. In order to store as many folds as possible in overlapping fashion, the drive wheel 42 and first idler wheel 44 preferably are sized such that each fold is substantially equal to the width of the chamber. The size of the gears/cog wheels (i.e. width of drive wheel 42 and first idler wheel 44) is customized to the required dimensions of the printer cartridge, so that chamber size is maximized. The folds remain in an overlapped, non-interfering state as a result of the semicircular or circular shape of the ribbon chamber. To maximize space for the ribbon chamber, the chamber surrounds reinking roller 30, and the outer edge of chamber 50 preferably comprises the outer wall of the printer cartridge in rear region 19.

The ribbon can be formed of a continuous strip of nylon textile, with the ends joined together to form a weld. Because of the unique semicircular arrangement of the chamber, which reduces wasted space, additional folds and thus a longer length of ribbon can be accommodated in chamber 50. The present invention can house up to 12 meters of ribbon in the printer cartridge, as opposed to prior art cartridges which hold approximately 5.5 meters of ribbon, where both were designed for use in the same lottery machine. Therefore, the presently described printer cartridge can store a substantially greater amount of ribbon in a printer ribbon cartridge designed to fit the available space in a particular application.

In a printer ribbon cartridge, the weld where the two ends of the ribbon are joined is the weakest part of the ribbon. In the present invention, the weld passes the print head less often, reducing wear on the ribbon in this critical region. Because a longer ribbon is used, more ink is contained in it and each segment of the ribbon engages the print head less often, thus increasing the useful life of the printer cartridge.

In operation, the printer ribbon cartridge of the present invention is installed in a machine having a print head which engages ribbon outside the cartridge in front of region 18 to print desired characters on paper. Ribbon 16 is driven through printer cartridge 10 by drive wheel 42 actuated from outside the cartridge. Drive wheel 42 meshes with first idler wheel 44 to drive the ribbon. First idler wheel 46 meshes with drive wheel 42, and thus provides additional gearing for overcoming friction forces generated along the ribbon path. The printer cartridge includes a sandwiched anti-zebra reinking roller 30 contacting ink transfer roller 26 which distributes ink to the ribbon. Downstream of drive assembly 40 is a ribbon chamber for storing continuous folds of ribbon produced by the drive wheel and first idler wheel. The chamber has a width equal to that of each fold, wherein the path follows a semicircular arrangement around the foam reinking roller, after which the ribbon exits the printer cartridge at exit area 22.

Although a preferred embodiment of the invention has been described using specific terms, such description is for illustrative purposes only, and it is to be understood that changes and variations may be made without departing from the spirit or scope of the following claims.

What is claimed is:

1. A printer ribbon cartridge, comprising:
a length of ribbon traveling through the cartridge;
a foam reinking roller attached to the cartridge, the reinking roller transferring ink to the ribbon and including upper and lower foam pieces with an ink impervious layer between the foam pieces for preventing ink leakage between the upper and lower foam pieces;
first and second cog wheels in meshing engagement to convey the ribbon therebetween, wherein at least one of the cog wheels is a drive wheel; and
a chamber downstream of the first and second cog wheels for storing the ribbon before it exits the cartridge.

2. The printer ribbon cartridge of claim 1, wherein the reinking roller has a height which is greater than the width of the ribbon.

3. The printer ribbon cartridge of claim 2, wherein the height of the reinking roller is about 2/3 greater than the width of the ribbon.

4. The printer ribbon cartridge of claim 1, wherein the upper foam piece is about twice the height of the lower foam piece.

5. The printer ribbon cartridge of claim 1, and further including an ink transfer roller for contacting the reinking roller to transfer the ink from the reinking roller to the ribbon.

6. The printer ribbon cartridge of claim 5, wherein the ink transfer roller has upper and lower arrangements of teeth, wherein the upper arrangement is staggered relative the lower arrangement.

7. The printer ribbon cartridge of claim 5, and further including an entry guide post upstream of the ink transfer roller in order to guide the ribbon into engagement with the ink transfer roller.

8. The printer ribbon cartridge of claim 1, and further including first and second flanges attached to either side of the reinking roller in order to prevent rubbing between the reinking roller and the cartridge.

9. The printer ribbon cartridge of claim 1, and further including a base for housing the printer ribbon cartridge, and a lid attached by hinges to the base.

10. A printer ribbon cartridge, comprising:
a length of ribbon traveling through the cartridge;
a foam reinking roller for transferring ink to the ribbon as it travels through the cartridge;
first and second cog wheels in meshing engagement with the ribbon disposed therebetween, wherein at least one of the cog wheels is a drive wheel; and
a chamber downstream of the first and second cog wheels for storing the ribbon before it exits the cartridge, wherein the chamber is of a semicircular shape and positioned to surround the foam reinking roller, thereby maximizing storage space for the ribbon in the cartridge.

11. The printer ribbon cartridge of claim 10, wherein the foam reinking roller has a cylindrical shape.

12. The printer ribbon cartridge of claim 10, and further including an ink transfer roller for contacting the reinking roller to transfer the ink from the reinking roller to the ribbon.

13. The printer ribbon cartridge of claim 12, wherein the ink transfer roller has upper and lower arrangements of teeth, wherein the upper arrangement is staggered relative the lower arrangement.

14. The printer ribbon cartridge of claim 10, wherein the chamber has a width approximately equal to a width of each fold produced when the ribbon passes through the first and second cog wheels.

15. A printer ribbon cartridge, comprising:
a base for housing the cartridge and a lid attached to the base;
a length of ribbon traveling through the cartridge;
a foam reinking roller for transferring ink to the ribbon as it travels through the cartridge, the reinking roller having a cylindrical shape and including first and second flanges, the first flange situated above the reinking roller to prevent the reinking roller from rubbing against the lid and the second flange situated below the reinking roller to prevent it from rubbing against the base of the cartridge, thereby ensuring proper rotation of the reinking roller;
first and second cog wheels in meshing engagement with the ribbon disposed therebetween, wherein at least one of the cog wheels is a drive wheel; and
a chamber downstream of the first and second cog wheels for storing the ribbon before it exits the cartridge.

16. The printer ribbon cartridge of claim 15, wherein the reinking roller has a height which is greater than the width of the ribbon.

17. The printer ribbon cartridge of claim 16, wherein the height of the reinking roller is about 2/3 greater than the width of the ribbon.

18. The printer ribbon cartridge of claim 16, wherein the upper foam piece is about twice the height of the lower foam piece.

19. The printer ribbon cartridge of claim 15, and further including an ink transfer roller for contacting the reinking roller to transfer the ink from the reinking roller to the ribbon.

20. The printer ribbon cartridge of claim 19, wherein the ink transfer roller has upper and lower arrangements of teeth, wherein the upper arrangement is staggered relative the lower arrangement.
